(19) United States
(12) Patent Application Publication
(10) Pub. No.: US 2013/0024010 A1
(43) Pub. Date: Jan. 24, 2013

(54) Blind Security

(71) Applicant: Alvin Dill, Centerville, MD (US)

(72) Inventor: Alvin Dill, Centerville, MD (US)

(21) Appl. No.: 13/550,469

(22) Filed: Jul. 16, 2012

Related U.S. Application Data
(60) Provisional application No. 61/572,426, filed on Jul. 15, 2011.

(51) Int. Cl. G05B 11/01

(52) U.S. Cl. 700/11

(57) ABSTRACT

The invention provides an electrically powered, fully automated, timed system for opening and closing the window blinds of an unoccupied house at pre-set or random hours, wherein the components are housed in a box mounted to the blind itself. The device can also be controlled by a remote control device.

### CLAIM OF PRIORITY

This patent application claims priority under 35 USC 119 (e) (1) from U.S. Provisional Patent Application Ser. No. 61/572,426 filed Jul. 15, 2011, of common inventorship herewith entitled, “Blind Security.”

### FIELD OF THE INVENTION

The present invention pertains to the field of window blind opening and closing devices.

### BACKGROUND OF THE INVENTION

The prior art has put forth several designs for devices which open and close window blinds.

U.S. Pat. No. 5,909,093 to Van Dinteren et al describes a automatically controlled blind arrangement.

U.S. Pat. No. 6,259,218 to Kovach et al describes a battery powered wireless remote control motorized window covering assembly having a microprocessor controller.

U.S. Pat. No. 6,850,017 to Domel et al describes a head rail mounted actuator for window coverings.

None of these prior art devices describe or suggest the present invention.

### SUMMARY OF THE INVENTION

It is an object of the present invention to provide an improved timed, electrically powered device for automatically opening and dosing a set of window blinds.

The invention has as an object to provide a manually or automatically controlled blind arrangement, which arranges for reduced power consumption.

It is a further object of the present invention to provide an automatically controlled blind arrangement which can be manufactured from relatively cheap components.

### BRIEF DESCRIPTION OF THE DRAWINGS

FIG. 1 shows a window equipped with blinds having the present invention for blind opening and closing mounted near the top of the blind itself above the wand attachment.

FIG. 2 shows a perspective view of the bracket for holding the present invention mounted to the top of the blind itself and below the blind horizontal mounting bracket.

FIG. 3 shows an exploded view of the controller unit of the present invention showing the attachment point of the unit above the wand and below the blind horizontal mounting bracket.

FIG. 4 shows a view of the controller unit of the present invention In place on a blind.

FIG. 5 shows a top perspective view of the controller unit of the present invention showing clips to hold the unit to the mounting bracket shown in FIG. 2.

FIG. 6 shows a front perspective view of the controller of the present invention with the flip up cover open to show the open and close controls and the battery indicator light.

FIG. 7 shows an alternative mounting configuration showing a view of the controller unit of the present invention mounted on the open and close hand wand.

FIG. 8 shows a side view of the controller unit of the present invention showing the tightening screw to hold the unit on place and the battery housing.

### DETAILED DESCRIPTION OF THE INVENTION

Glass windows let in the light of the world, affording us a view while protecting us from extremes of temperature and humidity. As essential as they are to our home and work life, however, there are two basic problems with windows. One is that, uncovered, they can let in too much light; and the second is that, uncovered, when were not looking out, other people might be looking in. Add the loss or gain of heat, and it becomes clear why curtains or blinds—which block light, and can be opened or closed by degrees—came into being. In many homes and offices today, Venetian blinds or a variation of these, vertical blinds, have taken the place of curtains. Blinds have the advantage of greater variability than curtains, since the individual louvers can be finely adjusted to let in or block outside light, while the blinds themselves stay in place—but contemporary blinds have a rather serious disadvantage as well. If we have to be away from home on a business or vacation trip, we must either leave the blinds open, inviting would-be burglars to get a view of our possessions; or leave them closed, which may likewise suggest to a burglar that the dwelling is unoccupied. The present invention to be described herein is intended to correct this problem.

Recognizing that homeowners need a variety of ways to make their dwellings appear occupied even when they are not, the present, invention was developed and is hereinafter referred to as “Blind Security.” Simply stated, the Blind Security is an electrically powered, fully automated, timed system for opening and closing—at pre-set or random hours—the window blinds of an unoccupied house. Manufactured by the Window Hardware, Drapery, Blinds and Shades industry, Standard Industrial Code 2591, the Blind Security consists of several components: 1) an electrical-supply component, including battery power, 110-volt household alternating current, or household current with a battery back-up, to operate: 2) a small electric rotary motor, which: 3) turns on and off according to a timer, this timer being set to open and close the blinds at regular times (or at random), by means of: 4) the blind's control-wand, to which the rotary motor is linked. As to the timing device, this can be pre-set by the homeowner, as noted; or it could be activated by a photo-electric “eye” or light-sensor that senses twilight, then close the blinds, and sense dawn, then open the blinds. In each case, once the Blind Security system was in place, the timer determines the opening and closing of the blinds, and do so at any time interval the homeowner chose. With the feature of household current backed up by emergency battery-power, the Blind Security system operates even in the event of a power outage.

In an alternative embodiment, the control mechanism comprises the capability of opening or closing the blinds to a variable degree. One means of accomplishing this is to include rheostat to allow a variable amount of power to the opening and closing motor. Another way of accomplishing this is to have predesignated settings of amount to tilt the blinds up or down.

Blind security is a timed system that will open and close window blinds at specified intervals. This invention eliminates the need for individuals to worry about their house looking unoccupied while they are at work, on vacation, or otherwise away from the home. The fully automated, timed system can be programmed to correspond with automatic light timers to effectively increase the appearance that someone is in the home, which is essential to preventing burglaries. Consumers will appreciate the convenience and efficiency that this invention affords.

When homeowners go on vacation or leave their home for an extended period of time, they often worry about break-ins. If an intruder knows that the occupants are out of town, they are more likely to burglarize the home. Because of this, many individuals go to a great deal of trouble to make it appear as though they are occupying the home. Many install light timers so that their interior and exterior lights go on and off throughout the day and night. Currently, there is not an efficient method for opening and closing window blinds. The stationary nature of the blinds may tip off an intruder that no one is home. An efficient option is needed.

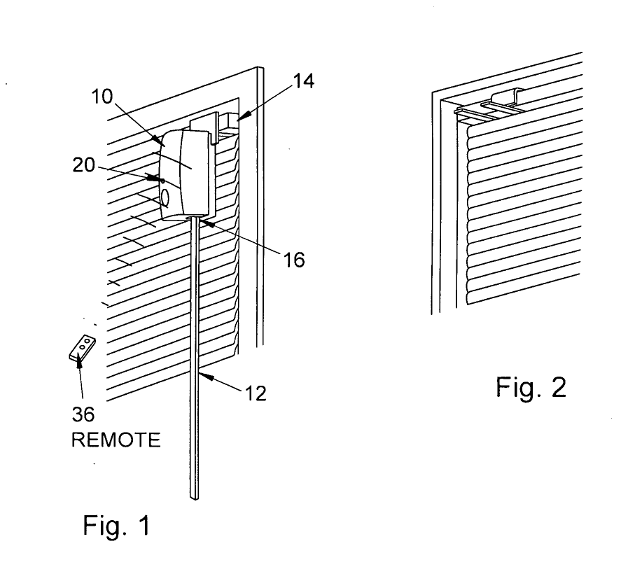

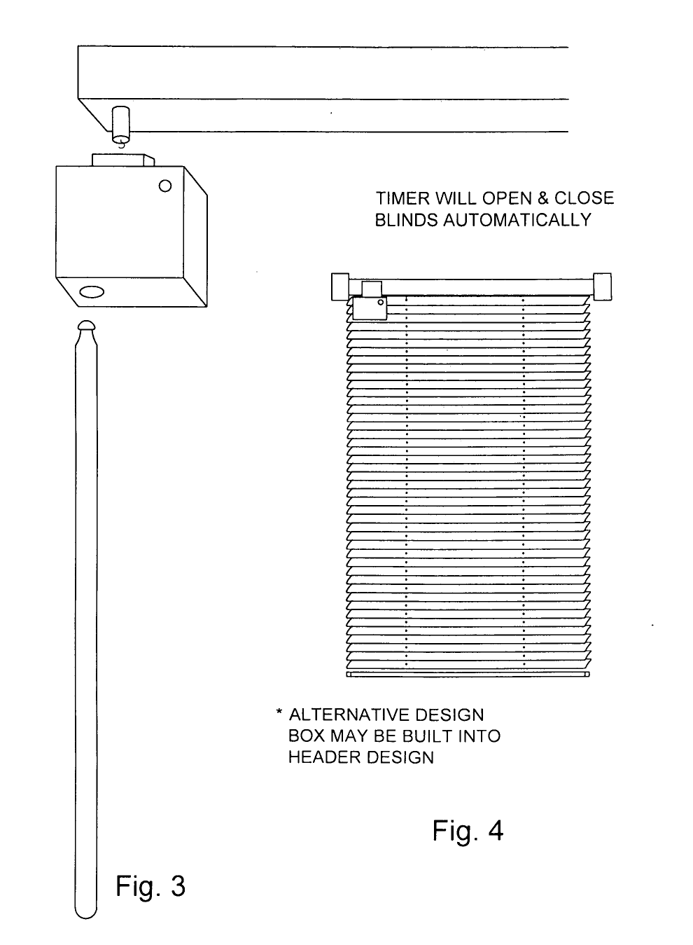

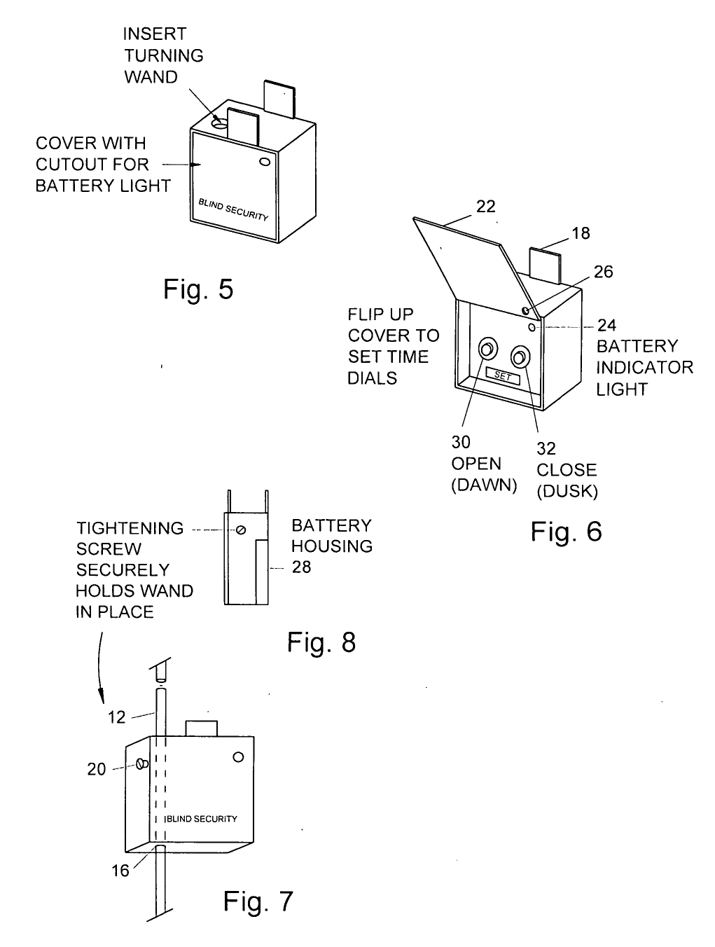

Blind Security is an automatic timer for window blinds that will open and close the blinds at selected intervals. The invention is comprised of a device that mounts onto a set of window blinds. The device is a small box 10 that can clip onto the window header or horizontal mounting bracket 14 of the blinds (FIG. 1). There is a clip at the front and back of the box to attach to the blind header 14 (FIG. 5). The box 10 has an opening 16 for the blind wand 12 to be inserted (FIGS. 1 and 7). A small turn pin 20 on the side of the box can be tightened to secure the wand in place (FIGS. 7 and 8). The box has a hinged front cover 22 (FIG. 6). The cover will have a logo on it, as well as a small cutout window 26 to show the battery indicator light 24. The battery indicator light 24 will be green when fully charged, and then fade to red as the batteries drain. The battery housing 28 is in the back of the box (FIG. 8). The lid 22 lifts up to expose a set of dials on the inside (FIG. 6). There are two dials, one represents open 30 and the other represents close 32.

The box 10 can be mounted at the top of the wand 12, below the blind mounting bracket 14, as shown in FIG. 1.

In an alternative embodiment, the box 10 can be mounted along the wand 12, as shown in FIG. 7.

The Blind Security, an automated system for opening and closing window blinds according to a pre-set timer, presents a number of distinct and significant benefits and advantages. Foremost is the added security that a homeowner experiences in knowing that his or her house appears occupied, even when they were away on business or vacation. In many cases, homeowners use timed devices to turn lights on and off, and this has been found to be effective. But adding the element of opening and closing blinds increases the appearance and impression that someone is in the house, and this impression is essential in dissuading burglars from breaking in. The Blind Security system can be pre-set, with the blinds in one room closing at one hour, the blinds in another room closing at a different time; the system can be set to open or close the blinds at different times on different days; and the system can be set to open and close the blinds on a random schedule: in each case, the appearance of an occupied house is strengthened, and any burglar casing the place would conclude that the homeowners were home. Thus, combining the Blind Security device with a timed lighting device is desirable, as these appearance-effects reinforce one another. The Blind Security system also operates even when the power supply was interrupted, in times of power outage—this is particularly important, since power outages and blackouts are often times of lawlessness and looting. Affordable, effective, and easily installed with a minimum of tools, the Blind Security provides a heightened level of security for homeowners, costing relatively little for a big payoff in both security and peace of mind.

A timed, electrically powered device for automatically opening and closing a set of window blinds, the Blind Security system opens and closes window blinds at pre-set times, discouraging burglary even when the dwelling was vacant.

The timers, motor controls and operating mechanisms useful for use in the present invention are commonly known in the art and a person of ordinary skill in the art will be able to construct the present invention using commercially available components.

The invention underlying the present disclosure relates to a manually or automatically controlled blind arrangement comprising an operating member for operating the blind arrangement, a motor for driving the operating member and a timer system, wherein the operating member opens and closes the blinds at predetermined times.

Such a manually or automatically controlled blind arrangement may be a slatted arrangement or a shade arrangement and can be used in home and office applications.

An automatically controlled blind arrangement in accordance with the present invention may be provided with manual operation equipment, such as a manual tilt or lift control.

An automatically controlled blind arrangement in accordance with the present invention may alternatively be provided with a remote control device 36 (FIG. 1) to operate the device.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. The invention claimed is a slatted blind control unit comprising; an electrical supply component, an electrical rotary motor, and a programmable timer, said electrical supply component, rotary motor and programmable timer being housed in a box fitted between the blind mounting bracket and the blind's control wand such that the blind is opened and closed as determined by a program entered by the user to the programmable timer.

2. The invention of claim 1 wherein the blind control unit further comprises a light sensor that may be the signal for opening or closing the blind.

3. The invention of claim 2 wherein the blind control unit may be programmed to move the position of the blinds such that the slats are partially open to a preset degree.

4. The invention claimed is a shade blind control unit comprising; an electrical supply component, an electrical rotary motor, and a programmable timer, said electrical supply component, rotary motor and programmable timer being housed in a small box and fitted to the blind's opening mechanism such that the blind is opened and closed as determined by a program entered by the user to the programmable timer.

5. The invention of claim 4 wherein the blind control unit further comprises a light sensor that may be the signal for opening or closing the blind.

6. The invention of claim 4 wherein the blind control unit may be programmed to move the position of the blind such that the blind is partially open to a preset degree.

7. The invention of claim 5 wherein the blind control unit may be programmed to move the position of the blind such that the blind is partially open to a preset degree.

8. The invention of claim 1 wherein the electrical supply is battery power.

9. The invention of claim 1 wherein the electrical supply is household current.

10. The invention of claim 1 wherein the electrical supply is a combination of battery and household current.

11. The invention of claim 1 wherein the blind control unit may be programmed to move the position of the blinds such that the slats are partially open to a preset degree.

12. The invention of claim 2 further comprising a remote control device to control the movement of the blinds.

13. The invention of claim 5 further comprising a remote control device to control the movement of the blinds.

14. The invention of claim 6 further comprising a remote control device to control the movement of the blinds.
